(19) United States
(12) Patent Application Publication
(10) Pub. No.: US 2014/0076419 A1
(43) Pub. Date: Mar. 20, 2014

(54) SELF ADJUSTING DETURBULATOR ENHANCED FLAP AND WIND DEFLECTOR

(71) Applicant: Sinhatech, (US)

(72) Inventor: Sumon K. Sinha, Oxford, MS (US)

(73) Assignee: Sinhatech, Oxford, CA (US)

(21) Appl. No.: 13/779,632

(22) Filed: Feb. 27, 2013

Related U.S. Application Data
(60) Provisional application No. 61/603,675, filed on Feb. 27, 2012.

(51) Int. Cl. F15D 1/10

(52) U.S. Cl. CPC F15D 1/10
USPC 137/347; 137/561 R; 137/343; 137/351

(57) ABSTRACT

A self adjusting flap is disclosed. The self adjusting flap comprises a solid body including a hinge. The flap includes a flexible skin stretched across an array of equi-spaced ridges on a convex surface of the hinged solid body, such that lift and drag forces due to fluid flow across it causes the flap to rotate about the hinge and automatically orient itself to minimize flow losses through turbulence while shielding objects downstream from flow induced drag.

### CROSS-REFERENCE TO RELATED APPLICATIONS

Under 35 USC 119(e), this application claims the benefit of U.S. Patent Application No. 61/603,675, entitled “SELF ADJUSTING DETURBULATOR ENHANCED FLAP AND WIND DEFLECTOR,” filed on Feb. 27, 2012. This application is also related to U.S. Pat. No. 7,422,051, Issued on Sep. 9, 2008, entitled “SYSTEM AND METHOD FOR USING A FLEXIBLE COMPOSITE SURFACE FOR PRESSURE-DROP FREE HEAT TRANSFER ENHANCEMENT AND FLOW DRAG REDUCTION” all of which is incorporated herein by reference.

### FIELD OF THE INVENTION

The present invention relates to a method for using turbulence modifying flow-control devices on hinged flow guiding flaps and flow diverting deflectors to reduce drag on bluff bodies, and increase lift generated by lifting bodies while resisting stall and mitigating drag increase.

### BACKGROUND OF THE INVENTION

Reduction of undesirable flow induced drag is important for enhancing the efficiencies of aircraft, automobiles, trucks, trains and boats. Additionally, lifting surfaces such as wings also need to maximize lift generation while reducing drag so as to maximize the lift to drag ratio and minimize the size of the wing. Designers usually streamline the shapes of cars, trucks and trains as far as practical to reduce flow induced drag without compromising functionality. For subsonic gas flows the primary drag generation mechanisms are viscous skin friction and separation of boundary layers leading to regions in the aft portion of the flow which have lower pressures than desired. Losses through turbulent eddies exacerbate pressure losses in regions of separated flow. Form or pressure drag arises out of the difference in pressures between the front and rear of the object. Wind deflectors can divert flow around an unstreamlined portion of a body to reduce pressure drag from flow impact. The wake of a wind deflector can however break down into large turbulent eddies, increasing drag. In addition, objects such as wings which are shaped to generate lift by inducing a pressure difference between the upper and lower surfaces. If however the flow separates from the wing surface, the lift is lost. A portion of the surface can be converted to a moveable flap to change the effective curvature and thereby increase lift when needed. Flap wake flows however break down in a manner similar to wind deflectors. This destroys the ability of the flap to augment lift. This also generates additional drag due to lift generation.

Generally, there is not a good solution to these problems. Accordingly, what is needed is a system and method for automatically orienting a flap or wind deflector while attenuating large turbulent eddies in the wake. The present invention also addresses such a need.

### SUMMARY OF THE INVENTION

A method for reducing drag by shielding unstreamlined objects or unstreamlined features of bodies completely from an oncoming fluid flow is disclosed using a hinged wind deflector capable of automatically orienting itself with the flow; while a flexible composite sheet deturbulator on its surface eliminates the impact of large turbulent eddies on the said unstreamlined features.

A self adjusting flap is disclosed. The self adjusting flap comprises a solid body including a hinge. The flap includes a flexible skin stretched across an array of equi-spaced ridges on a convex surface of the hinged solid body, such that lift and drag forces due to fluid flow across it causes the flap to rotate about the hinge and automatically orient itself to minimize flow losses through turbulence while shielding objects downstream from flow induced drag.

The self adjusting deturbulator enhancing wind deflector can also be used as a self actuated flap on an airfoil to delay the onset of stall and increase lift while mitigating drag increase.

The flexible composite sheet comprising a membrane, a substrate coupled to the membrane and a plurality of ridges coupled between the membrane and the substrate, wherein a vibratory motion is induced from the flow to at least one segment of a membrane spanning a distances, wherein the vibratory motion is reflected from at least one segment of the membrane to the flow, and; wherein a reduction in fluctuations is caused in the flow pressure gradient and freestream velocity U at all frequencies except around f, where f≈U/s.

In one embodiment the hinge in the self adjusting wind deflector or flap is replaced with a flexible material which behaves as a hinge while providing automatic restoration to a pre-desired orientation when the flow stops. The self adjusting wind deflector can be used to improve fuel economy of road and rail vehicles by shielding unstreamlined features such as the exposed corners of the carriages or trailers or difficult to streamline underchassis components.

### BRIEF DESCRIPTION OF THE DRAWINGS

FIG. 1 is a diagram of the deturbulator enhanced self adjusting wind deflector flap in accordance with the present invention.

FIG. 2 shows the effect of deturbulator (left) versus rigid surface (right) on wake of self adjusting wind deflector flap as revealed by oil flow on floor of tunnel. Flow is from left to right. The wind deflector flap has risen because of the flow. Stagnant oil drops show quiescent wake (Left) while non-stagnant wake is indicated by oil drops streaking (Right).

FIG. 3 shows deturbulator enhanced self adjusting wind deflector flaps installed on the bottom of the front bumper of a pickup truck to enhance fuel economy through aerodynamic drag reduction by shielding unstreamlined underchassis components from the oncoming airflow.

FIG. 4 shows the self adjusting deturbulator enhanced wind deflector flaps on an airfoil so as to prevent boundary layer separation from progressing upstream while increasing the effective camber of the airfoil to increase Lift, and remove skin friction by creating controlled thin separation regions in the wakes of the flaps.

FIG. 5 shows self adjusting wind deflector flaps used as jet nozzle walls. Deturbulator surfaced flaps (left) as per the present invention have lower spread with same fan compared to the spread of rigid wall flaps (right).

FIG. 6 is a sketch showing the use of deturbulator enhanced self adjusting wind deflector flaps for reducing aerodynamic drag from under chassis components and flow in gaps between carriages.

### DETAILED DESCRIPTION

The present invention relates to the use of devices capable of shielding unstreamlined features on an object from an oncoming airflow so as to reduce the overall drag on the object. Wind deflectors introduce additional drag and an improperly oriented wind deflector can introduce more drag than it saves. In addition the wake of a wind deflector very easily breaks down into large turbulent eddies. These eddies can hit the unstreamlined feature and increase drag even the feature is shielded from the main flow. The present invention simultaneously addresses both problems. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

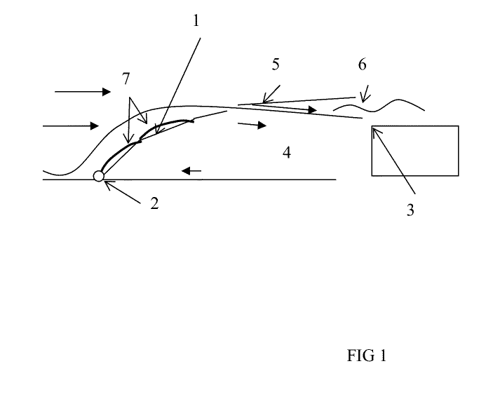

In order to automatically orient the wind deflector with the oncoming flow the deflector flap 1 embodied in this invention is hinged 2 or supported via flexible material to allow deflection angle to change with flow over the body as shown in FIG. 1. The cross section of the deflector flap resembles a cambered airfoil which generates aerodynamic lift under an approaching fluid flow. The lift generates a counter clockwise moment about the hinge and causes the deflector flap to rise. As the deflector flap raises its frontal projected area exposed to the oncoming flow increases. Ultimately equilibrium is reached where the deflector flap is optimally aligned with respect to the flow as shown in FIG. 1. If the magnitude or direction of the oncoming flow changes the orientation angle of the deflector flap changes accordingly. The weight of the deflector flap or friction and stiffness of the hinge 2 also influence the orientation of the deflector.

A rectangular feature 3 or any other non-streamlined feature can be located immediately behind the wind deflector and its presence will not influence the flow. In this shielded position the aforementioned unstreamlined feature will not contribute towards flow induced drag.

For the shielding to work the distance of the unstreamlined feature from the wind deflector needs to be kept extremely small. As the flow comes off the trailing edge of the wind deflector it encounters stagnant air 4 under it. The boundary between the stagnant air and the main flow creates a shear layer 5. This shear layer is extremely unstable and usually breaks down into turbulence creating eddies or vortices 6. These eddies smear out the shear layer. This reduces the efficacy of shielding since the larger eddies can periodically impact unstreamlined features like the corner of the rectangle in FIG. 1.

In order to prevent the breakdown of the shear layer 5 into large vortices a flexible composite surface deturbulator 7 is used on the upper surface of the wind deflector 1 as disclosed in in U.S. Pat. No. 7,422,051 assigned to the assignee of the present application. This patent is incorporated by reference in its entirety herein. The deturbulator 7 uses a flexible sheet stretched across an array of equally spaced ridges. Long wavelength disturbances which cause the shear layer 5 to breakdown induce similar wavelength traveling waves on the flexible composite surface of the deturbulator. These long waves are broken down into shorter waves of wavelength s, the spacing of the ridges on the substrate of the deturbulator. This effect is reflected back into the flow over the deturbulator on the wind deflector and convected downstream to the shear layer. As a result the shear layer breaks down into smaller eddies which are not large enough to impact the unstreamlined feature being shielded.

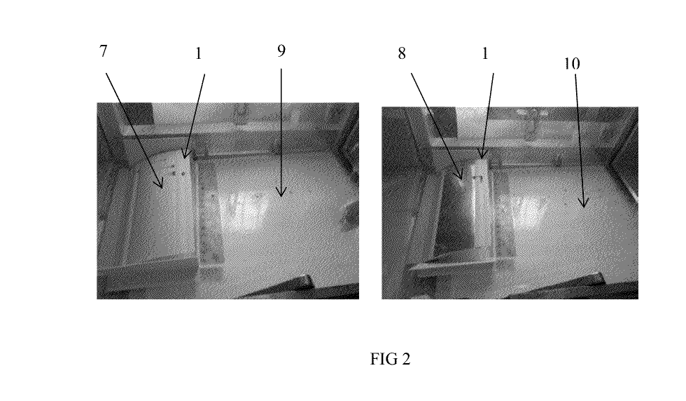

The ability of the wind deflector flap 1 to self adjust orientation, and the ability to control turbulence with the deturbulator 7 need to be simultaneously present for this concept to work as revealed in wind tunnel experiments in FIG. 2. The photograph on the left of FIG. 2 shows a self adjusting wind deflector flap with a flexible composite surface deturbulator 7, while the photograph on the right shows a self adjusting wind deflector flap with a rigid surface 8. No unstreamlined features are being shielded in this application. The self adjusting wind deflectors are acting as self actuated flaps. The presence of the deturbulator on the photograph on the left shows stagnant oil drops 9 on the floor of the tunnel in the wake of the flap. Since the oil drops do not streak the air flow above it can be inferred as stagnant. The photograph on the right with the rigid surface self actuating wind deflector flap shows oil streaking 10. This is because the increased thickening of the shear layer leads to rapid reattachment since no deturbulator is used. Self-adjusting wind deflector flap with rigid surface 8. The oil drops 10 streak backwards and forwards showing strong vortices in wake when the deturbulator is absent.

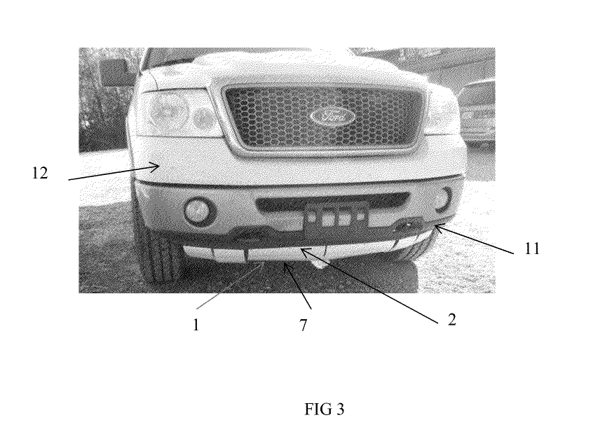

FIG. 3 shows an installation of deturbulator enhanced 7 self adjusting wind deflector flaps 1 hinged 2 on the bottom of the front bumper 11 of a pickup truck 12 to enhance fuel economy through aerodynamic drag reduction by shielding unstreamlined underchassis components from the oncoming airflow. This illustrates how the self adjusting wind deflector flaps can be used to shield any non-streamlined feature anywhere on a vehicle body in order to reduce drag. For net drag reduction to occur, the drag added by the deturbulator enhanced wind deflector flap needs to be lower than the drag of the bare unstreamlined feature.

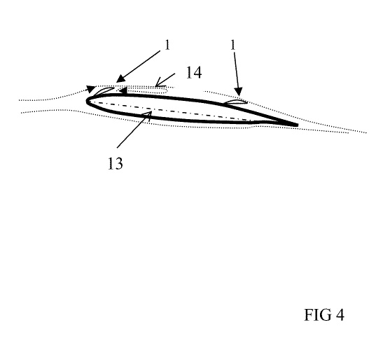

FIG. 4 shows the self adjusting deturbulator enhanced wind deflectors Flaps 1 on an airfoil 13 so as to prevent a separation vortex 14 from progressing upstream. Trapping the separation vortex 14 delays the onset of stall and increases the effective camber of the airfoil. This increases lift, and removes skin friction by creating controlled thin separation regions 14 in the wakes of the wind deflector flaps as per FIG. 2. The use of deturbulators on the wind deflector flaps 1 is critical to prevent the separated vortex 14 from breaking down through large turbulence mixing. Additional deturbulator enhanced flaps may be used as shown in FIG. 2 to condition the flow as needed. The overall installation needs to be customized to the particular airfoil shape and operating conditions. The net effect of the configuration of FIG. 4 is to increase lift to drag ratio of the airfoil and lower flow-induced oscillatory forces passed on to the structure holding the airfoil. The airfoil may be a wing, stabilizer, fuselage section, rotor blade, wind turbine blade, or compressor blade. This list is simply to suggest uses in similar situations and not meant to limit application of the deturbulator enhanced wind deflector flap invented here.

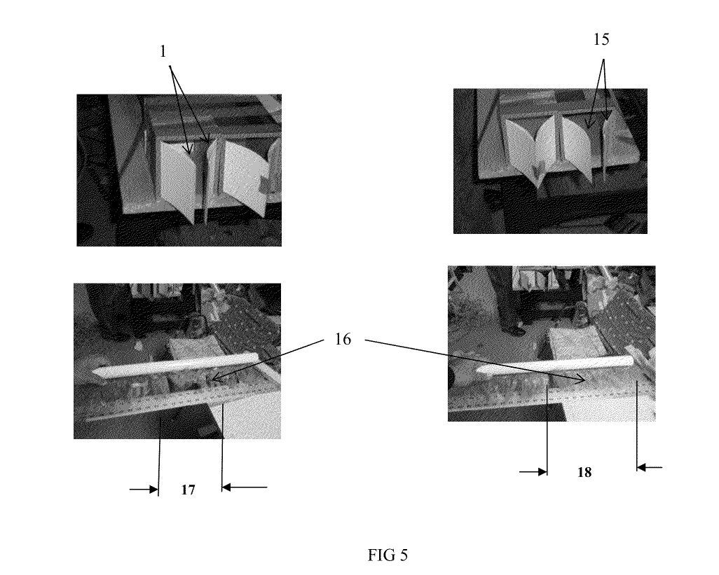

FIG. 5 shows self adjusting deturbulator enhanced wind deflector flaps 1 used as jet nozzles. Deturbulator surfaced flaps 1 as per the present invention have lower spread 17 with the same fan compared to the jet spread 18 when flaps with rigid surfaces 15 are used. The jet spreads 17 and 18 are visualized with streamers 16 at the same distance downstream of the nozzles.

Deturbulator enhanced self adjusting wind deflector flaps on jet nozzle walls 1 can be used to direct airflows to a very restricted area for spot cooling. It can also be used to make more efficient air curtains. It can also be used on jet and turbofan or ducted fan exhausts to augment thrust by increasing the exhaust velocity.

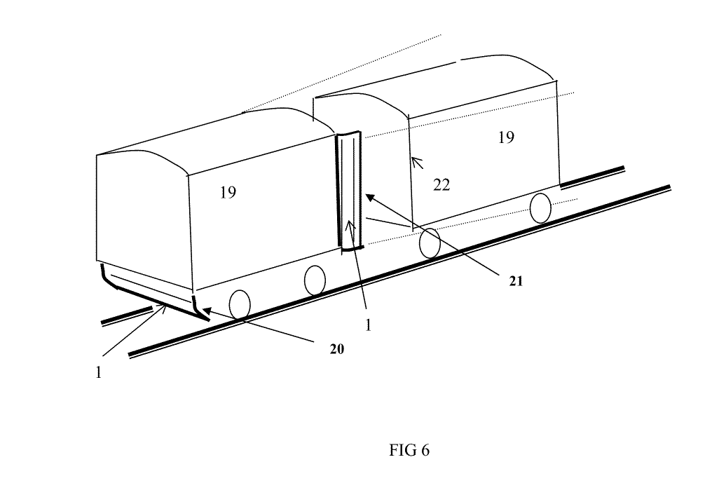

FIG. 6 shows a configuration for reducing aerodynamic drag of trains 19. For most trains 90% of the aerodynamic drag comes from a combination of airflow hitting under chassis components 20 and from the gaps between carriages 21.

The main flow, moving from left to right with respect to the train generates vortices in the turbulent boundary layer over the train. These vortices impact the corners of carriages 22. Deturbulator enhanced self adjusting wind deflector flaps 1 on the sides of the preceding carriage can divert the main flow off the carriage corners.

Deturbulator enhanced self adjusting wind deflector flaps 20 can reduce the impact of the airflow on un-streamlined under chassis components. This action is similar to FIG. 2.

The combination of 20 and 21 using deturbulator enhanced self adjusting wind deflectors flaps 1 as shown in FIG. 6 can result in 50% energy savings for high speed trains.

An arrangement similar to FIG. 6 can be used to streamline the tractor trailer gap in tractor trailer over the road trucks. In an arrangement similar to FIG. 2, self adjusting deturbulator enhanced wind deflector flaps can be used to shield the under chassis of all road vehicles, including automobiles, straight trucks, vans, pickup trucks, SUVs. Reducing drag will improve fuel economy. This will also extend the range and maximum speed. The last is especially critical for battery powered vehicles.

The self adjusting deturbulator enhanced wind deflector flaps can also be used to shield the riders of motorcycles and bicycles. This will reduce drag and add to driver comfort. For all of the applications listed herein the SADEW is also expected to enhance stability under gusty and crosswind conditions. It is also expected to reduce wind noise.

Although the present invention has been described in accordance with the embodiments shown, one of ordinary skill in the art will readily recognize that there could be variations to the embodiments and those variations would be within the spirit and scope of the present invention. For example, any of the embodiments shown could be used in a variety of applications and its use would be within the spirit and scope of the present invention. Accordingly, many modifications may be made by one of ordinary skill in the art without departing from the spirit and scope of the appended claims.

What is claimed is:

1. A self adjusting flap comprising:
a solid body including a hinge; and
a flexible skin stretched across an array of equi-spaced ridges on the convex surface of a hinged solid body, such that lift and drag forces due to fluid flow across it causes the self adjusting flap to rotate about the hinge and automatically orient itself to minimize flow losses through turbulence while shielding objects downstream from flow induced drag.

2. The self adjusting flap of claim 1, wherein the hinge is a deflectable solid member which provides a restoring moment so as to hold the self adjusting flap at a desired orientation while allowing adjustments with changes in the fluid flow over it.

3. The self adjusting flap of claim 1, wherein the self adjusting flap is part of a wind deflector attached to a vehicle so as to minimize aerodynamic drag of the vehicle by diverting flow away from un-streamlined components while attenuating turbulent losses.

4. The self adjusting flap of claim 2, wherein the self adjusting flap is part of a wind deflector attached to a vehicle so as to minimize aerodynamic drag of the vehicle by diverting flow away from un-streamlined components while attenuating turbulent losses.

5. The self adjusting flap of claim 1, wherein the vehicle comprises any of a car, truck or train.

6. The self adjusting flap of claim 2, wherein the vehicle comprises any of a car, truck or train.

7. The self adjusting flap of claim 1, wherein the self adjusting flap is attached to an airfoil, wing or lifting surface to automatically rise and arrest the upstream movement of boundary layer separation as angle of attack increases beyond stall.

8. The self adjusting flap of claim 2, wherein the self adjusting flap is attached to an airfoil, wing or lifting surface to automatically rise and arrest the upstream movement of boundary layer separation as angle of attack increases beyond stall.

9. The self adjusting flap of claim 7, wherein the self adjusting flap is utilized to delay a sudden reduction in lift as the angle of attack increases beyond the normal stall angle.

10. The self adjusting flap of claim 7, wherein the self adjusting flap is utilized to delay the sudden increase in drag as the angle of attack increases beyond the normal stall angle.

11. The self adjusting flap of claim 7, wherein the self adjusting flap is utilized to increase lift while mitigating increase in drag of a wing or airfoil or rotor blade.
